(19) United States
(12) Patent Application Publication
(10) Pub. No.: US 2026/0017985 A1
(43) Pub. Date: Jan. 15, 2026

(54) REMOTE TELE-BIOMETRICS FOR LIVENESS DETECTION AND DEEPFAKE VIDEO IDENTIFICATION

(71) Applicant: PureCipher Inc., Boca Raton, FL (US)

(72) Inventors: Wendy Chin, New York, NY (US); William Hahn, Delray Beach, FL (US); Prajwal Nagaraj, Boca Raton, FL (US); Mykyta Storozhenko, Boca Raton, FL (US)

(21) Appl. No.: 19/265,548

(22) Filed: Jul. 10, 2025

Related U.S. Application Data
(60) Provisional application No. 63/669,484, filed on Jul. 10, 2024.

(51) Int. Cl. G06V 40/40; G06V 10/25; G06V 10/26; G06V 10/30; G06V 10/56; G06V 10/82; G06V 20/00; G06V 20/40; G06V 40/10

(52) U.S. Cl. CPC G06V 40/45; G06V 10/25; G06V 10/273; G06V 10/30; G06V 10/56; G06V 20/46; G06V 20/95; G06V 40/15; G06V 10/82

(57) ABSTRACT

A system comprises a video capture module to acquire a video, a preprocessing module to enhance video quality and isolate regions of interest within the video, and a biometric data extraction module using remote photoplethysmography to extract heartbeat and SpO₂ levels from the video. A machine learning module analyzes the extracted biometric data for liveness and deepfake detection, a verification module to compare the analyzed data against known biometric signatures, and a user interface to display analysis results and alerts.

### CROSS-REFERENCE TO RELATED APPLICATIONS

The present invention claims the benefit to and priority of U.S. Provisional Application No. 63/669,484, filed Jul. 10, 2024. The entire disclosure of the above application is incorporated herein by reference.

### TECHNICAL FIELD

This application relates to the field of remote tele-biometrics, particularly focusing on methods and systems for detecting liveness and identifying deepfake videos by analyzing physiological parameters such as heartbeat and blood oxygen levels (SpO2—saturation of peripheral oxygen) through camera feeds.

### BACKGROUND

The rapid advancement in artificial intelligence and video editing technologies has led to the rise of deepfake videos. The proliferation of deepfake technology has introduced significant challenges to digital media authentication, cybersecurity, and public trust. Deepfakes—synthetically generated videos that realistically impersonate individuals—are increasingly being used in malicious activities such as identity fraud, misinformation campaigns, and cyber intrusions. Traditional video verification methods often rely on visual or auditory cues alone, which can be manipulated or mimicked using advanced generative algorithms.

Traditional methods of video verification are increasingly insufficient. Existing systems often suffer from limited accuracy, poor adaptability to varying video conditions, or lack of integration into comprehensive analysis pipelines. There remains a critical need for an intelligent, multimodal system capable of extracting, analyzing, and verifying physiological markers to detect deepfakes and validate user authenticity.

### SUMMARY

The present invention provides a method and system for detecting liveness and identifying deepfake videos by analyzing physiological parameters, specifically heartbeat and blood oxygen levels (SpO2), from camera feeds. This system leverages remote photoplethysmography (rPPG) techniques and machine learning algorithms to extract and analyze biometric data from video footage.

In accordance with one aspect of the present disclosure, a system comprises a video capture module to acquire a video, a preprocessing module to enhance video quality and isolate regions of interest within the video, and a biometric data extraction module using remote photoplethysmography to extract heartbeat and SpO₂ levels from the video. A machine learning module analyzes the extracted biometric data for liveness and deepfake detection, a verification module to compare the analyzed data against known biometric signatures, and a user interface to display analysis results and alerts.

In accordance with another aspect of the present disclosure, a method comprises capturing video footage of a subject, enhancing a video quality of the video footage, isolating one or more regions of interest within the video footage, and extracting biometric data from the video footage using remote photoplethysmography. The method also comprises analyzing the extracted biometric data with a machine learning algorithm, comparing the analyzed data against known biometric signatures to verify identity and liveness, and generating an alert if a deepfake is detected or liveness cannot be confirmed.

In accordance with another aspect of the present disclosure, a non-transitory computer-readable medium having program instructions stored thereon, configured to be executable by processing circuitry, wherein the program instructions, when executed by the processing circuitry, cause the processing circuitry to at least acquire video footage, identify a region of interest (ROI) within the video footage, and extract heartbeat and SpO₂ level data within the ROI from the video footage using remote photoplethysmography. The processing circuitry is further caused to analyze the extracted biometric data with a machine learning algorithm, compare the analyzed data against known biometric signatures to verify identity and liveness, and generate an alert if a deepfake is detected or liveness cannot be confirmed.

### BRIEF DESCRIPTION OF THE DRAWINGS

The drawings illustrate embodiments presently contemplated for carrying out the invention.

In the drawings:

FIG. 1 illustrates a system architecture diagram of the remote tele-biometrics system in accordance with an aspect of this disclosure.

FIG. 2 illustrates a video capture process illustrating camera capturing footage of a subject in accordance with an aspect of this disclosure.

FIG. 3 illustrates a preprocessing process showing steps such as noise reduction, color correction, and isolation of regions of interest in accordance with an aspect of this disclosure.

FIG. 4 illustrates a biometric data extraction using remote photoplethysmography (rPPG) technique in accordance with an aspect of this disclosure.

FIG. 5 illustrates a flowchart of the machine learning analysis process for detecting liveness and identifying deepfake videos in accordance with an aspect of this disclosure.

FIG. 6 illustrates a verification process comparing analyzed data with stored biometric signatures in accordance with an aspect of this disclosure.

FIG. 7 illustrates various application scenarios including security, healthcare, banking, and social media verification in accordance with an aspect of this disclosure.

FIG. 8 illustrates an example of deepfake detection showing comparative illustration of real and deepfake videos in accordance with an aspect of this disclosure.

FIG. 9 illustrates a block diagram in accordance with an aspect of this disclosure.

While the present disclosure is susceptible to various modifications and alternative forms, specific embodiments thereof have been shown by way of example in the drawings and are herein described in detail. It should be understood, however, that the description herein of specific embodiments is not intended to limit the present disclosure to the particular forms disclosed, but on the contrary, the intention is to cover all modifications, equivalents, and alternatives falling within the spirit and scope of the present disclosure. Note that corresponding reference numerals indicate corresponding parts throughout the several views of the drawings.

### DETAILED DESCRIPTION

Examples of the present disclosure will now be described more fully with reference to the accompanying drawings. The following description is merely exemplary in nature and is not intended to limit the present disclosure, application, or uses.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

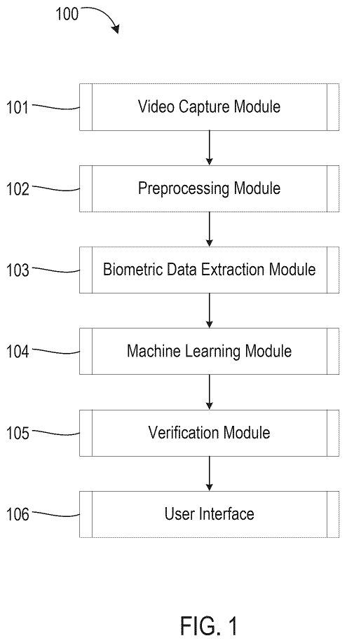

FIG. 1 illustrates a deepfake analysis training system 100 for capturing videos and training a machine learning module to analyze videos and detect authenticity according to an aspect of this disclosure. Deepfake analysis system 100 includes a video capture module (VCM) 101. The VCM 101 can be embodied in software, hardware, electronics, or some combinations of these components. In one embodiment, the VCM 101 obtains pre-recorded videos from various sources (e.g., file servers, websites, memory storage devices, cloud services, etc.). The pre-recorded videos are video recordings made with video equipment (e.g., webcams, smartphone cameras, professional video capture devices, etc.) and stored as video files. In another embodiment, the VCM 101 captures and records videos from live subjects and scenes with video equipment such as that described above. Alternatively, the VCM 101 captures and records videos from an interface with audiovisual feeds or digitally streaming content.

A preprocessing module (PM) 102 enhances the quality of the video feed and isolates regions of interest (ROIs) such as the face or exposed skin areas. The PM 102 can include software libraries and functions that analyze image data and/or video streams to identify ROIs. The software libraries can include graphics processing libraries that perform image and feature segmentation or other techniques.

A biometric data extraction module (BDEM) 103 utilizes remote photoplethysmography (rPPG) to extract heartbeat and SpO2 levels from the ROIs. Photoplethysmography is an optical technique used to detect volumetric changes in blood in peripheral circulation. rPPG is an optical technique for non-contact measurement of cardiovascular and respiratory signals using standard video cameras. By exploiting subtle, periodic changes in skin reflectance caused by blood volume pulsations, rPPG enables extraction of vital signs such as heart rate and blood oxygen saturation (SpO₂) without any physical sensors attached to the subject's body.

Human skin contains a dense network of microvasculature. With each heartbeat, arterial blood volume in the skin layers increases, altering how light is absorbed and reflected. Blood absorbs more light than surrounding tissue, producing periodic dips in reflected intensity. Hemoglobin's wavelength-dependent absorption profile causes color-specific changes in the red, green, and blue (RGB) components of reflected light. These imperceptible periodic color or chromatic fluctuations are captured by a camera when the subject's face or another vascularized region is illuminated under stable lighting.

A high-resolution camera records a continuous video stream of the subject, typically focusing on facial areas rich in capillaries (e.g., forehead, cheeks) under uniform, diffuse illumination. Computer-vision algorithms detect facial landmarks and define one or more ROIs where blood-volume changes manifest most strongly. Only pixels within these ROIs are processed further. For each frame, the mean intensity of each RGB channel within the ROI is computed over time. This yields raw photoplethysmographic waveforms embedded in color fluctuations.

Once raw RGB signals are available, they may be converted into clean physiological waveforms. Denoising and motion compensation techniques such as detrending, independent component analysis, and head-motion tracking are applied to suppress artifacts from subject movement or ambient light changes. Chrominance projection methods combine RGB channels to amplify the pulsatile component while canceling common-mode noise, enhancing the blood-volume signal. A finite-impulse-response (FIR) or infinite-impulse-response (IIR) filter isolates frequency bands corresponding to expected heart rates (e.g., 0.7-4 Hz) and respiratory rates (e.g., 0.1-0.5 Hz). The filtered signal is scanned for peaks to determine inter-beat intervals, from which instantaneous heart rate and heart rate variability are computed. By comparing the AC/DC ratios of the red and green channel signals, the system infers blood oxygen saturation based on differential absorption characteristics of oxy- and deoxy-hemoglobin.

A machine learning module (MLM) 104 utilizes a machine learning model to analyze the extracted biometric data to detect patterns indicative of liveness and deepfake characteristics. The MLM 104 can be trained using examples of live feeds of real persons to develop feature sets that are indicative of an authentic image and live persons. These feature sets can then be used to identify liveness and deepfake characteristics in images and video being analyzed. Certain feature sets and characteristics can be associated with certain individuals by the machine learning model.

In general, training the MLM 104 involves converting raw data into a learned mapping that can make predictions or classifications on new inputs. Several stages in the training ensure that the model generalizes well without overfitting.

In the initial stage, a representative dataset is assembled, comprising input-output pairs that reflect the variations the model will encounter in real-world deployment. For supervised learning, each input (e.g., whether an image, text snippet, or sensor reading) is meticulously annotated with its correct label or target value. Ensuring diversity in the dataset is critical; it must capture different lighting conditions, background noise levels, demographic variations, and other factors that could influence model performance.

Once the raw data is collected, it undergoes thorough preprocessing to enhance quality and consistency. Missing values, outliers, and inconsistencies are addressed through cleaning routines, and features are normalized or standardized to a common scale. Where appropriate, data augmentation techniques (e.g., such as random rotations of images or the addition of synthetic noise) are applied to bolster the model's robustness against minor perturbations.

With preprocessed data in hand, the next step is to select an appropriate model architecture based on the task at hand. Convolutional neural networks (CNNs) are typically chosen for image-related tasks, while recurrent neural networks (RNNs) or transformer architectures excel at handling sequential data. The depth of the network, layer types, and connectivity patterns are all calibrated to balance task complexity against available computational resources.

Training and optimization commence once the model structure is defined. The dataset is split into training, validation, and test subsets to facilitate unbiased performance monitoring. Model parameters are initialized (e.g., either randomly or from pretrained checkpoints) and iteratively updated by minimizing a loss function such as cross-entropy. Backpropagation coupled with an optimization algorithm like stochastic gradient descent or Adam guides these updates, and validation set metrics are tracked each epoch to guard against overfitting or underfitting.

Hyperparameter tuning runs in parallel with iterative training, involving systematic exploration of parameters such as learning rate, batch size, regularization strength (including dropout rates and weight decay), and architectural choices like layer count or neuron counts. Techniques such as grid search, random search, or Bayesian optimization identify the combination of hyperparameters that yields the best validation performance. Early stopping rules may also be employed to halt training once validation accuracy plateaus.

After training concludes, the model is rigorously evaluated on the held-out test set to estimate its real-world performance. Metrics such as accuracy, precision, recall, F1-score, and area under the receiver operating characteristic curve are computed to provide a multi-faceted assessment. An error analysis follows to uncover common failure modes, guiding future data collection efforts or model refinements.

Finally, the trained model is serialized and deployed into production environments (e.g., whether embedded devices, cloud services, or on-premises servers). Continuous monitoring captures incoming inputs and model outputs to detect performance drift over time. As new data becomes available or conditions evolve, the model may be retrained or fine-tuned to maintain accuracy and adapt to changing requirements.

Returning to FIG. 1, a verification module (VM) 105 compares the analyzed data against known biometric signatures to confirm the identity and authenticity of the individual. A user interface (UI) 106 provides a dashboard for displaying the analysis results and alerts.

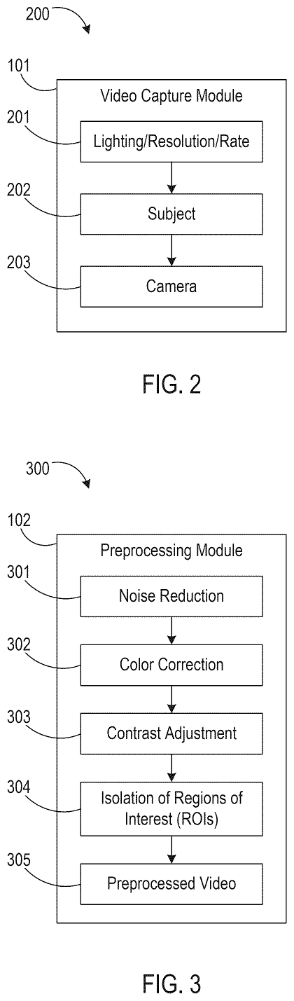

FIG. 2 illustrates aspects of a video capture/acquisition method 200 detailing aspects of the VCM 101 according to an aspect of this disclosure. In this method 200, video footage of a subject is captured or acquired using the VCM 101 described above. Proper lighting, resolution, and frame rate 201 are desirable to facilitate accurate data extraction in future steps of the deepfake analysis system 100 of FIG. 1. For example, a video resolution of 720p or higher allows for accurate biometric data extraction. A frame rate of 30 frames per second or higher allows for the capture of sufficient detail for rPPG analysis. Adequate and consistent lighting also ensures reliable biometric signal detection.

In an ideal video, an optimized video capture environment is present and tailored to enhance signal clarity and reproducibility. Proper lighting ensures uniform illumination of the subject's face, minimizing visual artifacts that could compromise data quality. The subject 202 is positioned within a predefined capture area to maintain consistency in focal length and framing, facilitating reliable feature tracking across frames. A digital camera 203 records high-resolution video footage of the subject's facial region, with sufficient frame rate to capture temporal changes in skin tone related to cardiovascular activity.

FIG. 3 illustrates aspects of a video processing method 300 detailing aspects of the PM 102 according to an aspect of this disclosure. The method 300 is a preprocessing step in which the captured video (from FIG. 2) is processed to enhance its quality. In a first, noise reduction step 301, visual noise, including, for example, static and compression artifacts, is filtered out to ensure clean signal extraction and reduce false biometric readings. In a color correction step 302, the video feed is normalized for color balance, compensating for ambient lighting conditions that might otherwise obscure subtle chromatic changes tied to cardiovascular activity. Contrast is adjusted at step 303 by applying dynamic contrast enhancement to emphasize tonal variations in skin texture, which supports the identification of microvascular pulsations through remote photoplethysmography (rPPG). Regions of interest (ROI) are isolated at deepfake analysis system at step 304. In this step 304, key regions (such as, for example, the forehead, cheeks, and periorbital area) are detected and isolated. These regions may be automatically detected using artificial intelligence or may be specified by a user. These areas are most responsive to physiological signals due to their consistent visibility and blood flow characteristics. Finally, a preprocessed video output is generated at step 305.

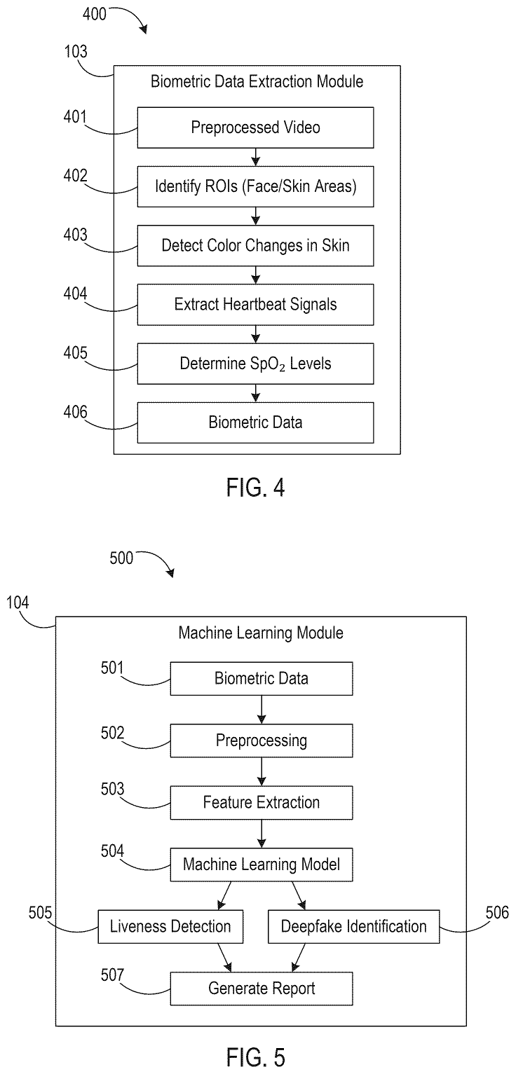

The refined and focused video stream from FIG. 3 is then forwarded to the BDEM 103 for use in a physiological analysis method 400 as illustrated FIG. 4 according to an aspect of this disclosure. In this method 400, remote photoplethysmography (RPPG) techniques are applied to the ROIs to detect subtle color changes in the skin caused by blood flow.

A preprocessed video generated by the video processing method 300 is obtained by the BDEM 103 at step 401. In a step 402 of region of interest (ROI) identification, the physiological analysis method 400 identifies facial regions rich in blood flow such as the forehead, cheeks, and periorbital zones that are sensitive to microvascular color shifts. While primarily focusing on the face, other skin-exposed areas may also be identified and used for analysis. At step 403, color change is detected across successive video frames. The system monitors and quantifies minor chromatic fluctuations in the skin. These changes arise due to pulsatile blood flow and are imperceptible to the human eye but analyzable via spectral decomposition.

Heartbeat signals are extracted at step 404. By analyzing periodic color changes, the method 400 extracts a waveform representative of the heart rhythm within the identified face/skin areas of the ROI(s). The step of extracting heartbeat signals can include the sub-steps of separating the video frames into red, green, and blue color channels, focusing on the channel which is most sensitive to blood volume changes, applying a bandpass filter (typically 0.7-4 Hz) on the green channel, for example, to isolate frequencies corresponding to normal heart rates (42-240 bpm), using independent component analysis (ICA) to separate the pulse signal from other variations, and applying peak detection algorithms to identify individual heartbeats and calculate heart rate. Temporal filtering and signal smoothing techniques may be applied to enhance the signal-to-noise ratio.

At step 405, blood oxygen saturation (SpO₂) level of the subject is determined. By leveraging the ratio of reflected red and green light intensities, the system infers peripheral blood oxygen saturation (SpO₂), providing a biometric signal data that are difficult to counterfeit synthetically. In one example, SpO₂ levels are determined by examining the ratio of red to infrared light absorption in the skin. The step of determining SpO₂ levels can include the sub-steps of analyzing both red and infrared color channels from the video feed, calculating the ratio of pulsatile to non-pulsatile components for each channel, determining the ratio of ratios (RoR) between the red and infrared channels, and using a calibration curve to convert the RoR to SpO₂ percentage.

Biometric data is compiled at deepfake analysis system 406 by extracting physiological signals (e.g., heart rate and SpO₂) and packaging them as feature vectors to be evaluated by the MLM 104 for liveness and authenticity detection.

Once the biometric data (including the heart rate and SpO₂ measurements) has been extracted, it is passed to the MLM 104, which is responsible for classifying the authenticity of the subject and identifying synthetic video artifacts. A data analysis method 500 is illustrated in FIG. 5 according to an aspect of this disclosure. This method 500 can include inputting the extracted biometric data into the MLM 104 and utilizing trained machine learning algorithms to distinguish between natural and manipulated biometric signals. Utilizing trained machine learning algorithms to distinguish between natural and manipulated biometric signals, machine learning models can trained to achieve at least a 95% accuracy in distinguishing real from deepfake videos.

The data analysis method 500 includes receiving the biometric data (e.g., raw physiological signals) determined in step 404 of method 400 at step 501. Data preprocessing is performed at step 502 in which the signals are cleaned and normalized to standardize temporal length, remove outliers, and smooth fluctuations that may distort feature extraction. In a step 503 of feature extraction, statistical, spectral, and temporal features as well as time-domain, frequency-domain, and non-linear features are derived from the biometric signals (e.g., including the heartbeat and SpO₂ signals). These may include signal coherence, peak frequency consistency, inter-beat intervals, and modulation depth—each of which contributes to capturing the “signature” of biological liveness.

At step 504, a trained neural network MLM (e.g., such as a recurrent neural network (RNN)), convolutional neural network (CNN), or a transformer model) ingests the extracted features and performs multi-label classification. The MLM may use ensemble learning methods, combining multiple classifiers such as anomaly detection algorithms, random forests, support vector machines, and convolutional neural networks in its analysis to identify unusual patterns in the biometric data that may indicate manipulation. Step 504 determines whether the subject is exhibiting genuine, biologically consistent signals or if indicators suggest deepfake manipulation.

Based on the training at step 504, liveness detection (step 505) and deepfake identification (step 506) are generated. Based on model output, the method 500 makes a probabilistic determination that the target video is of a live subject and is, thus, authentic or is a fake or spoofed individual and is, thus, synthetically altered or generated footage. The results are compiled into a structured report at step 507, including confidence scores, anomaly heatmaps, and a final authentication verdict. This report is delivered to the User Interface for review by end-users or integrated system components.

In addition to training the MLM 104 on videos in which liveness should be detected, known deepfake or other falsified videos can be used to train the MLM 104 to identify the fake videos. Fake video detection may include detecting inconsistencies in the biometric patterns that potentially indicate deepfake manipulation. The step of detecting inconsistencies in the biometric patterns can include analyzing temporal consistency of heartbeat and SpO₂ signals across video frames, checking for physiologically impossible or highly improbable combinations of heart rate and SpO2 levels, and/or examining the correlation between visible motion artifacts and changes in biometric signals.

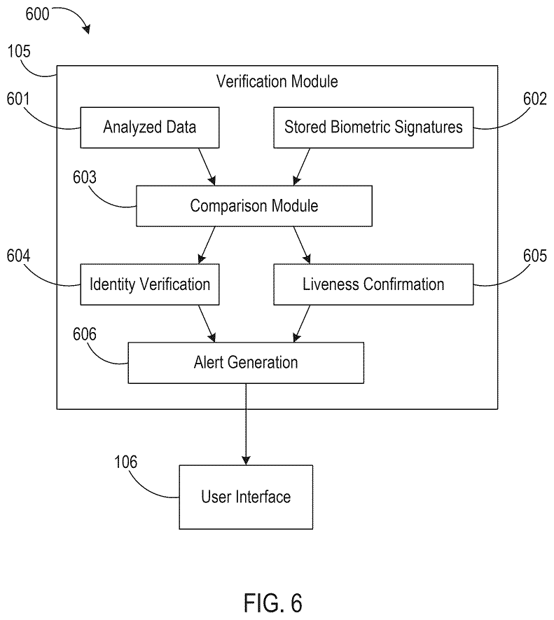

FIG. 6 illustrates a verification method 600 according to an aspect of this disclosure. The method 600 analyzes the results of the data analysis method 500 to determine the accuracy of the training. In this method 600, the analyzed data is compared with stored biometric signatures to verify the subject's identity and liveness. Additionally, an alert can be generated if the system detects a false positive (e.g., identifying a video as a deepfake when the video is known to be of a real person) or a false negative (e.g., failing to identify a video as legitimate when the video is known to be of a real person).

At step 601, the output signals and classification results from the MLM 104 and method 500 are passed as inputs for comparative verification. Step 602 includes accessing stored biometric signatures. In this step 602, the system accesses a secure repository containing biometric baseline profiles for enrolled users or previously authenticated individuals. These profiles include time-stamped heart rate variability patterns, SpO₂ level trends, and other physiological signatures known to correlate with the target identity.

A comparison submodule performs dual checks at step 603. A first check includes data matching in which real-time biometric vectors are compared against the stored signatures using similarity metrics (e.g., Euclidean distance, cosine similarity, dynamic time warping). A second check includes liveness confirmation, which evaluates whether the incoming data shows natural biometric variability consistent with a live human subject rather than a prerecorded or synthetically generated sequence.

Identity verification and liveness confirmation are performed at steps 604, 605. Identity information in the analyzed data is compared with the identity information in the stored biometric signatures at step 604. In response to detecting an error in the analyzed data, a corresponding alert is generated at step 606. Liveness confirmation is compared in the same manner. Based on an error in the analyzed data, step 606 generates an alert. The alert is displayed on the UI 106.

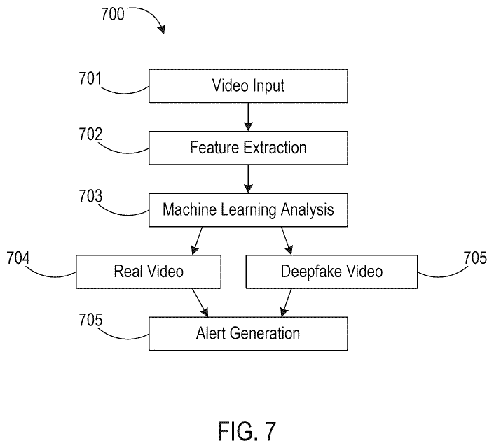

Once MLM 104 has been trained and validated, the system enters its operational phase to analyze live or recorded biometric data. FIG. 7 illustrates a video verification method 700 that analyzes live or recorded biometric data according to an aspect of this disclosure. The video verification method 700 includes retrieving (step 701) a pre-recorded video from file storage or retrieving live video feed as described herein. From the video input, rPPG techniques are used to extract features of the subject in the video at step 702. In this step, the incoming physiological waveforms undergo the same cleaning routines applied during training: outlier removal, normalization to a fixed scale, and temporal smoothing. This ensures consistency between training and inference data distributions. In addition, key statistical and spectral features (e.g., such as mean inter-beat interval, signal variance, peak frequency, and SpO₂ modulation ratio) are computed from the preprocessed signals.

The precomputed feature vectors are fed into the loaded, trained machine learning model at step 703. The model performs its trained analysis and sequences to generate a classification of the video. At step 704, the video is classified as a real video where the subject in the video has been analyzed as having a pulse and other biometrical features detectable using the trained analysis. At step 705, the video is classified as a false or deepfake video where the subject in the video cannot be analyzed as having a pulse or other biometrical features or liveness cannot be confirmed. The system compiles a structured report at step 706. The report may include, for example, confidence scores for the video's classification, diagnostic feature maps highlighting anomaly regions, and/or a definitive verdict on liveness and authenticity. This report is then forwarded to the user interface for real-time display or downstream action.

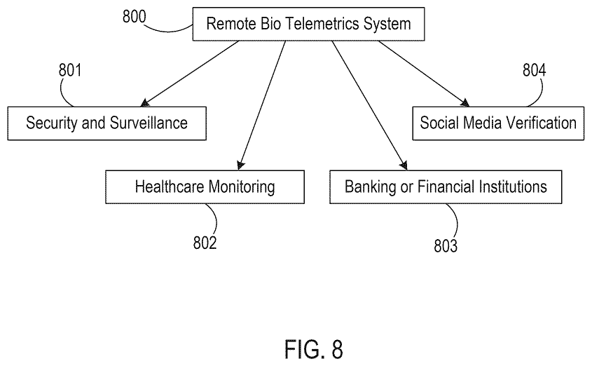

FIG. 8 illustrates a block diagram showing various different fields that may benefit from aspects of this disclosure. A remote bio telemetrics system 800, for example, may provide the data analysis system described herein for providing the reality or artificial nature of subjects connected by livestream or found in recorded videos to other fields. For security and surveillance 801, the data analysis system may provide enhancement in the verification process in security cameras to prevent identity fraud. For healthcare 802, remote patient monitoring systems may be ensured of the liveness of patients during virtual consultations. For financial services 803, authentication processes in online banking and financial transactions may be confirmed. For social media and content verification 804, social media platforms may be able to verify the authenticity of user-generated content.

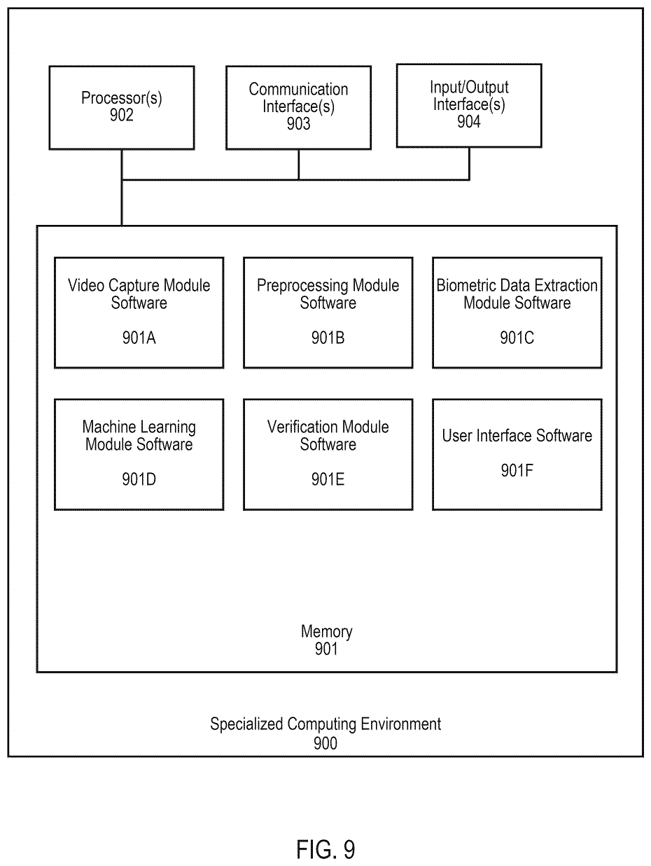

One of the above-described techniques can be implemented in or involve one or more special-purpose computer systems having computer-readable instructions loaded thereon that enable the computer system to implement the above-described techniques. FIG. 9 illustrates an example of a specialized computing environment 900 that can be used to implement the above-described processes according to an aspect of this disclosure. The specialized computing environment 900 is not intended to suggest any limitation as to scope of use or functionality of a described embodiment(s).

With reference to FIG. 9, the computing environment 900 includes at least one processing unit/controller 902 and memory 901. The processing unit 902 executes computer-executable instructions and can be a real or a virtual processor. In a multi-processing system, multiple processing units execute computer-executable instructions to increase processing power. The memory 901 can be volatile memory (e.g., registers, cache, RAM), non-volatile memory (e.g., ROM, EEPROM, flash memory, etc.), or some combination of the two. The memory 901 can store software and data used for implementing the above-described techniques, including video capture module software 901A, preprocessing module software 901B, biometric data extraction module software 901C, machine learning module software 901D, verification module software 901E, and user interface software 901F.

All of the software stored within memory 901 can be stored as a computer-readable instructions, that when executed by one or more processors 902, cause the processors to perform the functionality described above.

Processor(s) 902 execute computer-executable instructions and can be a real or virtual processors. In a multi-processing system, multiple processors or multicore processors can be used to execute computer-executable instructions to increase processing power and/or to execute certain software in parallel.

Specialized computing environment 900 additionally includes a communication interface 903, such as a network interface, which is used to communicate with devices, applications, or processes on a computer network or computing system, collect data from devices on a network, and implement encryption/decryption actions on network communications within the computer network or on data stored in databases of the computer network. The communication interface conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Specialized computing environment 900 further includes input and output interfaces 904 that allow users (such as system administrators) to provide input to the system to set parameters, to edit data stored in memory 901, or to perform other administrative functions.

An interconnection mechanism (shown as a solid line in FIG. 9), such as a bus, controller, or network interconnects the components of the specialized computing environment 900.

Input and output interfaces 904 can be coupled to input and output devices. For example, Universal Serial Bus (USB) ports can allow for the connection of a keyboard, mouse, pen, trackball, touch screen, or game controller, a voice input device, a scanning device, a digital camera, remote control, or another device that provides input to the specialized computing environment 900.

Specialized computing environment 900 can additionally utilize a removable or non-removable storage, such as magnetic disks, magnetic tapes or cassettes, CD-ROMs, CD-RWs, DVDs, USB drives, or any other medium which can be used to store information and which can be accessed within the specialized computing environment 900.

Having described and illustrated the principles of our invention with reference to the described embodiment, it will be recognized that the described embodiment can be modified in arrangement and detail without departing from such principles. Elements of the described embodiment shown in software can be implemented in hardware and vice versa.

In view of the many possible embodiments to which the principles of our invention can be applied, we claim as our invention all such embodiments as can come within the scope and spirit of the present disclosure and equivalents thereto.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the invention is not to be seen as limited by the foregoing description but is only limited by the scope of the appended claims.

What is claimed is:

1. A system comprising:
a video capture module to acquire a video;
a preprocessing module to enhance video quality and isolate regions of interest within the video;
a biometric data extraction module using remote photoplethysmography to extract heartbeat and SpO₂ levels from the video;
a machine learning module to analyze the extracted biometric data for liveness and deepfake detection;
a verification module to compare the analyzed data against known biometric signatures; and
a user interface to display analysis results and alerts.

2. The system of claim 1, wherein the video capture module captures video at a minimum resolution of 720p and a frame rate of 30 frames per second.

3. The system of claim 1, wherein the preprocessing module performs noise reduction, color correction, and contrast adjustment on the acquired video.

4. The system of claim 1, wherein the biometric data extraction module detects heartbeat signals by analyzing periodic color fluctuations in human skin.

5. The system of claim 1, wherein the biometric data extraction module determines SpO₂ levels by examining the ratio of red to infrared light absorption in human skin.

6. The system of claim 1, wherein the machine learning module utilizes trained algorithms to distinguish between natural and manipulated biometric signals.

7. The system of claim 1, wherein the verification module generates an alert if a deepfake is detected or liveness cannot be confirmed.

8. A method comprising:
capturing video footage of a subject;
enhancing a video quality of the video footage;
isolating one or more regions of interest within the video footage;
extracting biometric data from the video footage using remote photoplethysmography;
analyzing the extracted biometric data with a machine learning algorithm;
comparing the analyzed data against known biometric signatures to verify identity and liveness; and
generating an alert if a deepfake is detected or liveness cannot be confirmed.

9. The method of claim 8, wherein the biometric data comprises heartbeat data and SpO₂ level data.

10. The method of claim 9, wherein extracting the heartbeat data comprises:
separating video frames into a plurality of color channels;
applying a bandpass filter to a green channel of the plurality of color channels;
using independent component analysis to isolate a heartbeat pulse signal within the green channel; and
applying a peak detection algorithm to the heartbeat pulse signal to calculate a heart rate.

11. The method of claim 10, wherein extracting the SpO₂ level data comprises:
analyzing red and infrared color channels of the plurality of color channels;
calculating a ratio of pulsatile to non-pulsatile components in each of the red and infrared color channels;
determining a ratio of ratios between the red channel and the infrared channel; and
converting the ratio of ratios to SpO₂ percentage using a calibration curve.

12. The method of claim 8, wherein capturing the video footage comprises capturing streaming video footage.

13. The method of claim 12, wherein capturing the streaming video comprises capturing the streaming video footage at a minimum resolution of 720p.

14. The method of claim 12, wherein capturing the streaming video footage comprises capturing the streaming video footage with at least 30 frames per second.

15. The method of claim 8, wherein capturing the video footage comprises obtaining a pre-recorded video footage stored in a file.

16. The method of claim 8, wherein enhancing the video quality comprises:
applying noise reduction to the video footage;
applying color correction to the video footage; and
adjusting a contrast of the video footage.

17. A non-transitory computer-readable medium having program instructions stored thereon, configured to be executable by processing circuitry, wherein the program instructions, when executed by the processing circuitry, cause the processing circuitry to at least:
acquire video footage;
identify a region of interest (ROI) within the video footage;
extract heartbeat and SpO₂ level data within the ROI from the video footage using remote photoplethysmography;
analyze the extracted biometric data with a machine learning algorithm;
compare the analyzed data against known biometric signatures to verify identity and liveness; and
generate an alert if a deepfake is detected or liveness cannot be confirmed.

18. The non-transitory computer-readable medium of claim 17, wherein the program instructions that cause the processing circuitry to extract the heartbeat and SpO₂ level data cause the processing circuitry to:
separate video frames into a plurality of color channels;
apply a bandpass filter to a green channel of the plurality of color channels;
use independent component analysis to isolate a heartbeat pulse signal within the green channel;
apply a peak detection algorithm to the heartbeat pulse signal to calculate a heart rate;
analyze red and infrared color channels of the plurality of color channels;
calculate a ratio of pulsatile to non-pulsatile components in each of the red and infrared color channels;
determine a ratio of ratios between the red channel and the infrared channel; and
convert the ratio of ratios to SpO₂ percentage using a calibration curve.

19. The non-transitory computer-readable medium of claim 17, wherein the program instructions that cause the processing circuitry to identify the ROI cause the processing circuitry to receive a user input identifying an area of a subject within the video footage, the area defining a target for extracting the biometric data.

20. The non-transitory computer-readable medium of claim 17, wherein the program instructions that cause the processing circuitry to identify the ROI cause the processing circuitry to automatically identify an area of a subject within the video footage without user input, the area defining a target for extracting the biometric data.
